(19) United States
(12) Patent Application Publication
(10) Pub. No.: US 2026/0032713 A1
(43) Pub. Date: Jan. 29, 2026

(54) INDICATING IDENTITY TYPE TO AMBIENT INTERNET OF THINGS (AIOT) DEVICES

(71) Applicant: Lenovo (United States) Inc., Morrisville, NC (US)

(72) Inventors: Genadi VELEV, Darmastadt (DE); Andreas KUNZ, Ladenburg (DE); Thomas Ralph LUETZENKIRCHEN, Munich (DE)

(21) Appl. No.: 19/341,794

(22) Filed: Sep. 26, 2025

(51) Int. Cl. H04W 72/51; G16Y 10/75

(52) U.S. Cl. CPC H04W 72/51; G16Y 10/75

(57) ABSTRACT

Various aspects of the present disclosure relate to communicating types of identifiers to ambient Internet of Things (AIOT) devices, such as during an inventory procedure or other AIOT operations. For example, an AIoT function (AIOTF) may determine the type of identifier to be used during the inventory procedure and communicate the type of identifier to an AIOT reader device. The AIoT reader device may include an indication of the type of identifier in a paging message to the AIOT device (e.g., along with device identification information, such as a value of an identifier for the AIoT device).

### TECHNICAL FIELD

The present disclosure relates to wireless communications, and more specifically to communications with ambient Internet of Things (AIoT) devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for communicating with AIoT devices, such as communications that facilitate indicating identifier type information to AIoT devices during inventory procedures or other operations.

A network function for wireless communication is described. The network function may be configured to, capable of, or operable to perform one or more operations as described herein. For example, the network function may comprise one or more memories and one or more processors coupled with the one or more memories and individually or collectively configured to cause the network function to select a value of an identifier for an AIoT device and a type of the identifier for the AIoT device and transmit, to an AIoT reader device, the selected value of the identifier for the AIoT device and the type of the identifier for the AIoT device.

A method performed or performable by the network function is described. The method may comprise selecting a value of an identifier for an AIoT device and a type of the identifier for the AIoT device and transmitting, to an AIoT reader device, the selected value of the identifier for the AIoT device and the type of the identifier for the AIoT device.

In some implementations of the network function and method described herein, the type of the identifier includes an AIoT device permanent identifier, a temporary identifier (T-ID), a concealed T-ID, a T-ID generated based on a concealed AIoT device permanent identifier, or filtering information.

In some implementations of the network function and method described herein, the network function and method may further be configured to, capable of, performed, performable, or operable to determine whether privacy protection is enabled for AIoT, transmit a request for a T-ID associated with the AIoT device based at least in part on privacy protection being enabled for AIoT, wherein the type of the identifier corresponds to the T-ID, and receive the T-ID associated with the AIoT device.

In some implementations of the network function and method described herein, to transmit the selected value of the identifier for the AIoT device and the type of the identifier for the AIoT device, the network function and method may further be configured to, capable of, performed, performable, or operable to transmit an AIoT inventory request message comprising at least two parameters, including a parameter corresponding to the value of the identifier for the AIoT device and a parameter corresponding to the type of the identifier for the AIoT device.

In some implementations of the network function and method described herein, to transmit the selected value of the identifier for the AIoT device and the type of the identifier for the AIoT device, the network function and method may further be configured to, capable of, performed, performable, or operable to transmit an AIoT inventory request message that includes the type of the identifier within device identification information for the AIoT device.

In some implementations of the network function and method described herein, the network function and method may further be configured to, capable of, performed, performable, or operable to receive a request message for an AIoT inventory service or an AIoT command service, wherein the value of the identifier for the AIoT device and the type of the identifier for the AIoT device is selected in response to, or based at least in part on, the received request message for the AIoT inventory service or the AIoT command service.

In some implementations of the network function and method described herein, the network function is an AIoT function (AIOTF).

A reader device for wireless communication is described. The reader device may be configured to, capable of, or operable to perform one or more operations as described herein. For example, the reader device may comprise one or more memories and one or more processors coupled with the one or more memories and individually or collectively configured to receive a first message that comprises a value of an identifier for an AIoT device and a type of the identifier for the AIoT device and transmit a second message to the AIoT device that includes the value of the identifier for the AIoT device and the type of the identifier for the AIoT device.

A method performed or performable by the reader device is described. The method may comprise receiving a first message that comprises a value of an identifier for an AIoT device and a type of the identifier for the AIoT device and transmitting a second message to the AIoT device that includes the value of the identifier for the AIoT device and the type of the identifier for the AIoT device.

In some implementations of the reader device and method described herein, the second message is a paging message that includes the type of the identifier.

In some implementations of the reader device and method described herein, the second message indicates the type of the identifier as a separate parameter.

In some implementations of the reader device and method described herein, the second message indicates the type of identifier as part of a device identification information parameter.

In some implementations of the reader device and method described herein, the reader device is a radio access network (RAN) node.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive a paging request message that comprises a value of an identifier for an AIoT device and an indication of a type of the identifier for the AIoT device, identify AIoT device identification information for the UE having the indicated type, and compare the value of the identifier for the AIoT device with values of the identified AIoT device identification information.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive a paging request message that comprises a value of an identifier for an AIoT device and an indication of a type of the identifier for the AIoT device, identify AIoT device identification information for the UE having the indicated type, and compare the value of the identifier for the AIoT device with values of the identified AIoT device identification information.

A method performed or performable by the UE is described. The method may comprise receiving a paging request message that comprises a value of an identifier for an AIoT device and an indication of a type of the identifier for the AIoT device, identifying AIoT device identification information for the UE having the indicated type, and comparing the value of the identifier for the AIoT device with values of the identified AIoT device identification information.

In some implementations of the UE, processor, and method described herein, the type of the identifier for the AIoT device includes an AIoT device permanent identifier, a T-ID, a concealed T-ID, a T-ID generated based on a concealed AIoT device permanent identifier, or filtering information.

In some implementations of the UE, processor, and method described herein, the UE, processor, and method may further be configured to, capable of, performed, performable, or operable to transmit a reply message when the value of the identifier for the AIoT device matches a value of the identified AIoT device identification information.

In some implementations of the UE, processor, and method described herein, wherein the type of the identifier is filtering information, and wherein, to compare the value of the identifier for the AIoT device with values of the identified AIoT device identification information, the UE, processor, and method may further be configured to, capable of, performed, performable, or operable to compare each bitstring of each filtering element within the filtering information with a corresponding component of a permanent identifier of the UE, and when each bitstring matches its corresponding component, determine that the permanent identifier matches the filtering information.

In some implementations of the UE, processor, and method described herein, a non-access stratum (NAS) layer of the UE identifies the AIoT device identification information for the UE having the indicated type.

In some implementations of the UE, processor, and method described herein, the UE is an AIoT device.

### BRIEF DESCRIPTION OF THE DRAWINGS

FIG. 1 illustrates an example of a wireless communications system in accordance with aspects of the present disclosure.

FIGS. 2A-2B illustrate example topologies for AIOT devices in accordance with aspects of the present disclosure.

FIG. 3A-3B illustrate example system architectures for communicating with AIoT devices in accordance with aspects of the present disclosure.

FIGS. 4A-4B illustrates example paging IDs in accordance with aspects of the present disclosure.

FIG. 5 illustrates a messaging flow for performing IoT operations in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by a reader device in accordance with aspects of the present disclosure.

FIG. 11 illustrates a flowchart of a method performed by an NE in accordance with aspects of the present disclosure.

### DETAILED DESCRIPTION

A wireless communications system may include one or more IoT devices, which may be an AIoT device, a passive-IoT device, and/or a passive radio frequency identification (RFID) tag (e.g., sticker, tag, badge, patch, or the like) that supports one or more functionalities at lower cost, complexity, and/or maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). Thus, an AIoT device may be any device that is ambient power-enabled, such as battery-less devices or devices with limited storage capabilities (e.g., devices that store a limited amount of energy using capacitors) or other restricted or limited capabilities.

A network node, such as a UE, NE (e.g., a base station), and/or a radio access network (RAN) node may operate as a reader device that interacts with AIoT devices. For example, a network node configured or operating as a reader device may transmit a carrier wave to an AIoT device to excite (e.g., activate) the AIoT device to perform backscattering transmissions or other communications, or communicate a message to an AIoT device during device selection procedures, or may read or receive the backscattering transmissions. The network node may interact with various network functions, such as an AIoT function (AIOTF) that communicates directly with the network node and/or an application function (AF) that communicates with the network node via the AIOTF.

The AIoT device may perform one or more operations (e.g., transmission, reception, via backscattering) using the stored harvested energy. For example, the AIoT device may be a passive RFID tag equipped on an object or other device enabling for tracking of a location of the object or the other device using stored harvested energy. Example use cases or IoT operations (e.g., AIoT operations) performed by AIoT devices (e.g., one or multiple) include inventory taking or procedures (e.g., tracking and/or acknowledgement of a presence of an object) and/or command procedures (e.g., read, write, control, enable, disable, and so on), sensor data collection, asset tracking, actuator control, and so on.

In some cases, such as during an inventory procedure, an AIoT device may receive AIoT device identification information from a reader device. The AIoT device identification information may include multiple different types of identifiers, including a temporary identifier, a permanent identifier, and/or filtering information (e.g., as a paging ID). Not being aware of the type of identifier in the paging ID, the AIoT device may perform comparisons of values of identifiers within the paging ID to values of all identifiers stored within the AIoT device (e.g., values of identifiers of different types). Given the limited energy-storage capacity of the AIoT device, performing multiple or superfluous comparisons can be an inefficient and wasteful use of the device's energy.

The present disclosure introduces methods for communicating types of identifiers to AIoT devices, such as during an inventory procedure or other AIoT operations. For example, an AIOTF may determine the type of identifier to be used during the inventory procedure and communicate the type of identifier to the reader device. The reader device may include an indication of the type of identifier in a paging message to the AIoT device (e.g., along with device identification information, such as a value of an identifier for the AIoT device).

The AIoT device, upon receiving the paging message, may determine and/or identify the type of identifier in the paging message and perform a single comparison of the received device identification information (e.g., a value or values of identifiers) to device identity information stored by the AIoT device. Thus, the AIoT device, having knowledge of the type of identifier, can perform an efficient determination of confirming its identity during the AIoT operation, among other benefits.

Aspects of the present disclosure are described in the context of a wireless communications system.

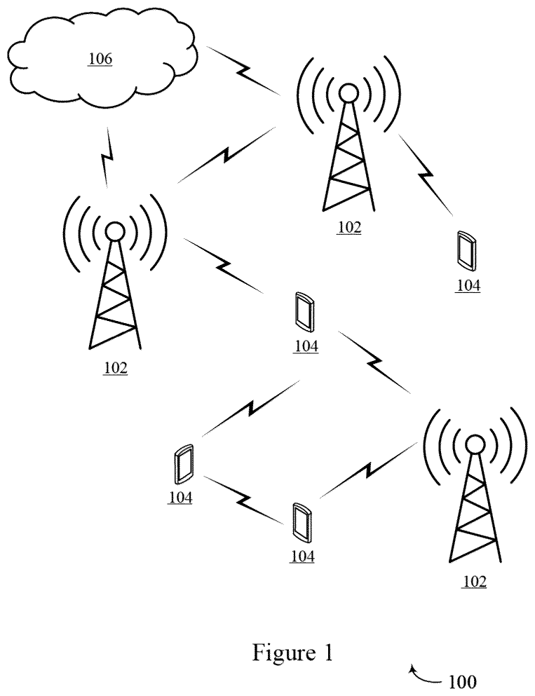

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of a UE 104), such as AIoT devices. As described herein, an AIoT device may be associated with a low complexity profile (e.g., low power consumption, less capabilities) and/or be implemented as an ambient-power enabled ultra-low complexity device with ultra-low power consumption.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

In some implementations, the wireless communications system 100 may implement various topologies and deployment scenarios, such as an example topology in which an NE (e.g., a base station or other network entity) functions as a reader (e.g., a reader device) and a source of a carrier wave (e.g., for exciting an AIoT device to perform backscattering), another example topology in which the NE functions as the reader and a different device (e.g., a UE) functions as the source of the carrier wave, another example topology in which the NE controls operations and the UE (e.g., the UE 104) or other network entities (e.g., nodes) function as readers and/or carrier wave sources, and the like.

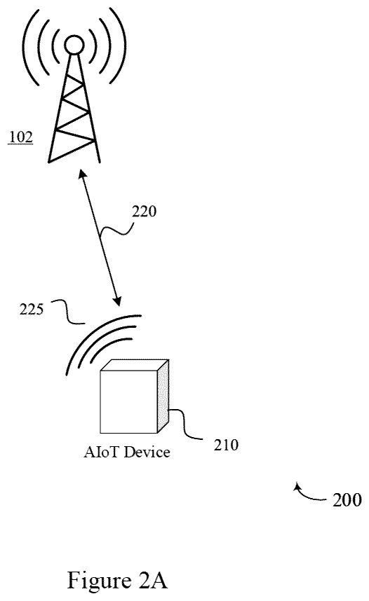

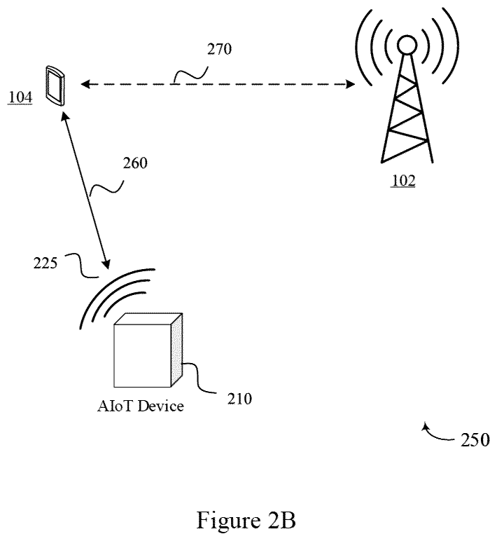

FIG. 2A illustrates an example topology 200 for AIoT devices in accordance with aspects of the present disclosure. In some examples, the topology 200 may implement or be implemented by aspects of the wireless communications system 100. For example, the topology 200 may be implemented by an NE and/or a UE, which may be an example of an NE 102 and a UE 104 as described with reference to FIG. 1. In the example of FIG. 2A, an AIoT device 210, which may be an example of a UE 104 as described with reference to FIG. 1, may directly and bidirectionally communicate with the NE 102. The NE 102 may provide communication coverage via one or more cells, for example a macro cell, a small cell, a micro cell, or other types of cells, or any combination thereof. A communication link 220 between the NE 102 and the AIoT device 210 may support communication (e.g., transfer, transmission, reception, etc.) of AIoT data (e.g., via backscattering 225) and/or other signaling (e.g., control information, data). In an example implementation, both the AIoT device 210 and the NE 102 are located indoors (with a micro cell being part of a group of cells or NEs 102).

FIG. 2B illustrates an example topology 250 for AIoT devices in accordance with aspects of the present disclosure. In some examples, the topology 250 may implement or be implemented by aspects of the wireless communications system 100. For example, the topology 250 may be implemented by an NE and/or a UE, which may be an example of an NE 102 and a UE 104 as described with reference to FIG. 1. In the example of FIG. 2B, a UE 104, or another network node, may act (e.g., function, operate) as an intermediate node between an NE 102 and an AIoT device 210. For example, the UE 104 may function as an emitter and/or reader, where the UE 104 sends (e.g., outputs, transmits) carrier waves to the AIoT device 210, which excite (e.g., activate) the AIoT device 210, enabling or causing the AIoT device 210 to perform the backscattering transmissions 225, which may be received and read (e.g., demodulated, decoded) by the UE 104.

The AIoT device 210 may directly and bidirectionally communicate with the UE 104 (e.g., which may relay data to the NE 102, serving a macro cell). A communication link 260 between the UE 104 and the AIoT device 210 and/or a link 270 between the UE 104 and the NE 102 may support communication (e.g., transfer, transmission, reception, etc.) of AIoT data (e.g., via backscattering 225) and/or other signaling (e.g., control information, data). In an example implementation, the AIoT device 210 and the UE 104 are both located indoors, and the NE 102 is located outdoors (with the macro cell being part of a group of cells or NEs 102).

The AIoT device 210 may communicate with the intermediate node (e.g., the UE 104 or another network node) and/or the network (e.g., via the NE 102) using a reduced set of components (e.g., protocol layers, circuitry, hardware). For example, the AIoT device 210 may be an IoT device of ultra-low complexity with ultra-low power consumption (e.g., sufficient for low-end IoT applications), having a radio protocol stack architecture that is comparatively compact with respect to typical NR architectures for communication devices.

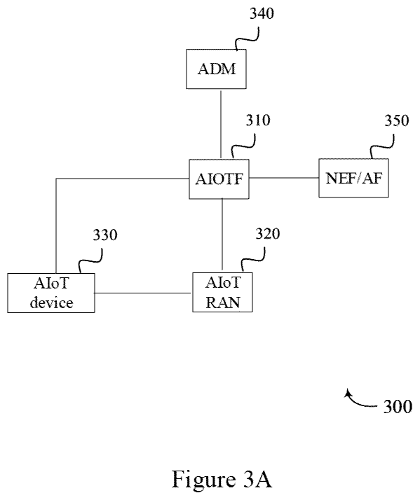

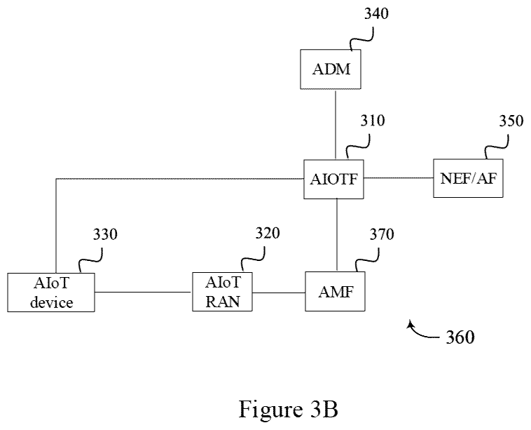

FIG. 3A-3B illustrate example system architectures for communicating with AIoT devices in accordance with aspects of the present disclosure. FIG. 3A depicts a direct path (or direct connectivity) architecture 300, wherein an AIOTF 310 communicates directly with an AIoT RAN 320 via a reference point (e.g., AIOT2) when performing AIoT operations. FIG. 3B depicts an indirect path (or indirect connectivity) architecture 360, where the AIOTF 310 communicates indirectly with the AIoT RAN 320 via an AMF 370 (e.g., via an AIOT3 reference point between the AIOTF 310 and the AMF 370.

In some cases, the AIOTF 310 is a network function in the CN 106 that supports AIoT services (e.g., inventory/command procedures). The AIOTF 310 may select AIoT RAN nodes and may support one or more BS readers (where a BS reader serves a defined service area within the AIoT RAN 320). The AIOTF 310 receives AIoT service requests from an AF 350 (e.g., or network exposure function (NEF)) and triggers the AIoT RAN 320 to perform AIoT service operations with or towards AIoT devices (e.g., the AIoT device 330). The AF 350 may be an AIoT service consumer or operator.

The AIoT RAN 320 may be the NE 102, the UE 104, or other device that is associated with a reader device, as described herein. The reader device may be coupled to the AIoT RAN 320 via an RRC protocol and configured send and receive AIoT messages to/from an AIoT device 330 via the RRC protocol to the AIoT RAN 320. The AIoT RAN 320 may communicate to/from the AIOTF 310.

In some cases, the AIoT device 330 and the AIOTF 310 may exchange messages via a reference point (e.g., AIOT1). The AIOT1 reference point may be used to transfer AIoT data (e.g., data to be written to the AIoT device 330 or read from the AIoT device 330) between the AIoT device 330 and the AIOTF 310.

An AIoT Data Management (ADM) 340 is configured to manage AIoT device profile data. The ADM 340 may be similar to a unified data management (UDM) or unified data repository (UDR) function, where data profiles and subscription data for UEs 104 (e.g., AIoT devices) is stored. The ADM 340 manages and stores profiles of AIoT devices (e.g., the AIoT device 330), including AIoT device permanent IDs, corresponding credentials, last known location information, and so on. The AIOTF 310 may exchange messages with the ADM 340 via an AIOT6 reference point.

In some cases, a globally unique AIoT device permanent identifier is allocated to each AIoT device. The AIoT device permanent identifier may be assigned by an operator or a third party and is used to identify an AIoT device (e.g., the AIoT device 330) and locate an entity where device information is stored.

As described herein, the AIOTF 310 may determine or select a type of identifier for the AIoT device 330 to be used during an AIoT operation (e.g., an inventory procedure) and communicate the type of identifier to the AIoT RAN 320, along with a value for the identifier of the AIoT device 330. The AIOT RAN 320, via an associated reader device, may include an indication of the type of identifier in a paging message to the AIoT device 330. The reader device may transmit the indication of the type of the identifier along with device identification information (e.g., a value of an identifier for the AIoT device that may be based at least in part on the type of the identifier) during an inventory procedure (or other AIoT operation) with the AIoT device 330.

For example, an AIoT paging message may include an indication about the type of identifier of the AIoT device 330 in a paging ID of the message. The indication may be within an NG application protocol (NGAP) AIoT message from the AIOTF 310 to the AIOT RAN 320. The AIOTF 310 may determine or select the type of identifier to include in the paging ID (e.g., the type of AIoT device identification information included in the paging ID).

In some examples, upon receiving the indication, the AIoT device 330 may create or generate a corresponding internal identity (e.g., a value) having the same type, and perform a comparison of the generated internal identity with the received paging ID. The type of identifier (or AIoT identification info type) may indicate one or more types of identifiers, as follows:

Type A, an AIoT device permanent identifier type, which may be selected or used when a privacy proception of the paging ID is not required (e.g., the AIoT device permanent identifier may not be encrypted or concealed);

Type B, a stored (or pre-configured) T-ID type, which may be derived and/or stored at the ADM 340 from a previous exchange or operation with the AIoT device 330;

Type C, a concealed and stored T-ID type, which may be a type of identifier that is generated by inputting a stored (or pre-configured) T-ID into a concealment mechanism. A concealment mechanism may be a cryptographic mechanism that generates encrypted or “hidden” output information based on input information (e.g., the clear text identifier is input information and the concealment mechanism outputs a concealed (e.g., encrypted, hidden, obfuscated) identifier);

Type D, a concealed T-ID, which may be a type of identifier that is generated by inputting a permanent identifier for the AIoT device 330 into the concealment mechanism;

Type E, filtering information and/or a filtering information type, which may be in clear text (e.g., in an information element (IE)), and which may be identification information for multiple AIoT devices (e.g., a group of AIoT devices). For example, filtering information may comprise a permanent identifier, with one or more parts of the identifier being masked (e.g., not used). A receiving AIoT device compares the unmasked parts to corresponding parts of the AIoT device permanent identifier to determine whether the identifiers match; and so on.

In some cases, the T-ID may be categorized as depicted in Table 1 below.

TABLE 1

| Enumeration value for T-ID type | Description |
|---|---|
| “CONCEALED_FROM_STORED” | Concealed T-ID type derived |
| | from the stored T-ID. |
| “CONCEALED_FROM_PERMA- | Concealed T-ID type derived |
| NENT” | from AIoT device permanent |
| | identifier. |
| “STORED_NO_UPDATE” | Stored T-ID type, e.g., no |
| | update required |
| “STORED_UPDATE_WITH_COM- | Stored T-ID type, update with |
| MAND” | command, where the T-ID is |
| | updated every time when an |
| | AIoT command request is |
| | sent to the AIoT device. |
| “STORED_UPDATE_NO_COM- | Stored T-ID type, update with |
| MAND” | inventory, where the T-ID is |
| | updated every time when an |
| | AIoT inventory request is |
| | sent to the AIoT device. |

In some cases, the type of identifier (or AIoT identification info type) may be indicated via a parameter (e.g., an AIoT identification info type parameter), such as a numerical value that is associated with and specific to a certain type of identifier (for the AIoT device identification information). Thus, in some cases, the types of identifiers may be presented as “A, B, C, . . . , N,” “1, 2, 3, . . . , N,” and so on.

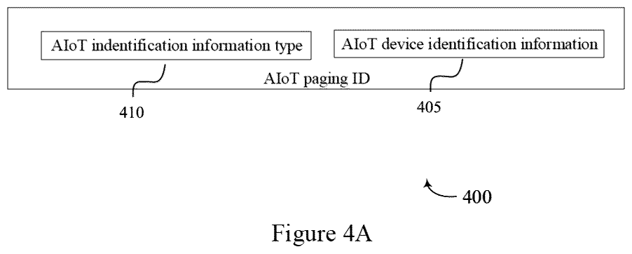

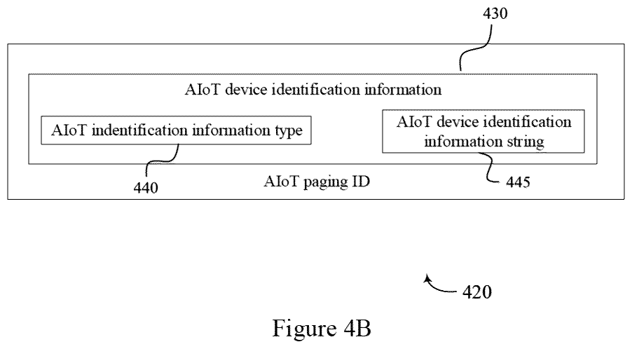

As described herein, the indication of the type of identifier may be messaged between functions (e.g., between the AIOTF 310 and the AIOT RAN 320 and/or the AIoT RAN 320 and the AIoT device 330) in a variety of formats. FIG. 4A illustrates an example paging ID 400 in accordance with aspects of the present disclosure. The paging ID 400 includes an independent or separate parameter (e.g., IE) for AIOT device identification information 405 (e.g., a value of the identifier for the AIoT device 330) and an independent or separate parameter (e.g., IE) for an AIoT identification information type 410 (e.g., a type of the identifier for the AIoT device 330).

FIG. 4B illustrates another example paging ID 420 in accordance with aspects of the present disclosure. In the paging ID 420, an AIoT identification information type 440 (e.g., a type of the identifier for the AIoT device 330) is part of a parameter for AIoT device identification information 430.

For example, the AIoT device identification information 430 may include a component (e.g., implemented as a type value (e.g., using 3 bits)) for the AIoT identification information type 440 and a component for an AIoT identification information string 445, which contains information (e.g, a value) that identifies the AIoT device 330, such as specific filtering information, a specific T-ID, a specific device permanent identifier, and so on. In some cases, the component for the AIoT identification information type 440 may be in clear text (e.g., not encrypted or concealed), while the component for an AIoT identification information string 445 may be encrypted and/or concealed.

As described herein, various different AIoT operations or procedures, such as those supported by the deployment scenarios described herein, may implement the technology described herein.

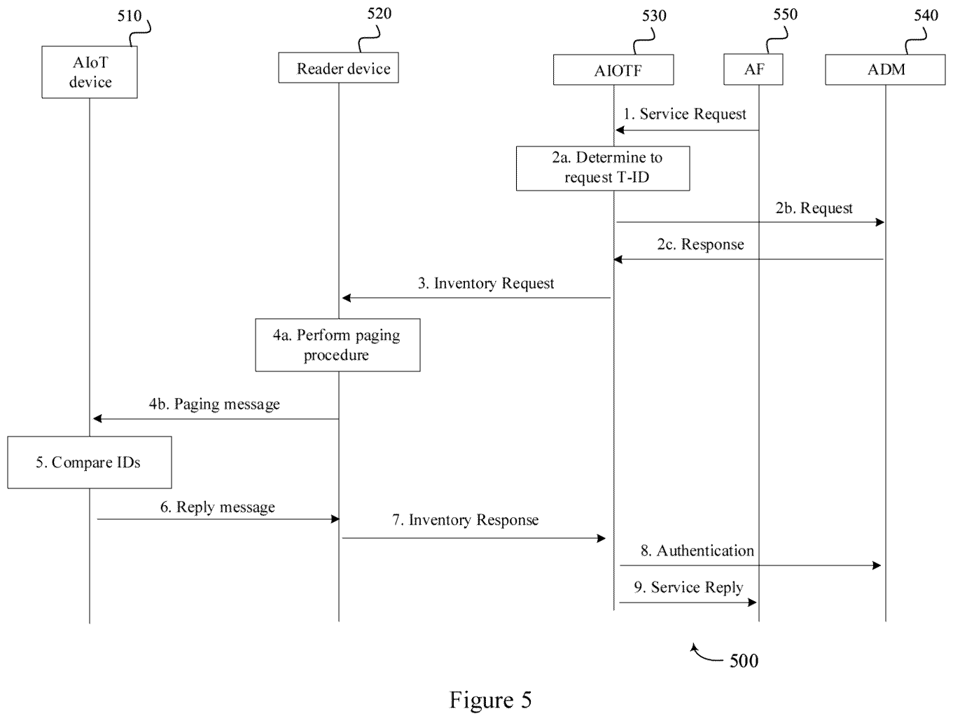

FIG. 5 illustrates a messaging flow 500 for performing IoT operations in accordance with aspects of the present disclosure. The messaging flow 500 may implement various aspects of the present disclosure described herein. For example, the messaging flow 500 may include an AIoT device 510, a reader device 520 (e.g., a RAN node), an AIOTF 530, an ADM 540, and an AF 550, which may be examples of AIoT devices, reader devices, AIOTFs, ADMs, and AFs as described herein. In the following description of the messaging flow 500, the operations between the AIoT device 510, the reader device 520, the AIOTF 530, the ADM 540, and the AF 550 may be performed in different orders or at different times. Some operations may also be omitted, or other operations may be added. Although the AIoT device 510, the reader device 520, the AIOTF 530, the ADM 540, and the AF 550 are shown performing the operations of the messaging flow 500, some aspects of some operations may also be performed by other entities of the messaging flow 500 or by entities that are not shown in the messaging flow 500, or any combination thereof.

In some examples, the messaging flow 500 supports or represents an AIoT inventory procedure, such as an inventory procedure performed by the AIoT device 510 and the reader device 520, which may be the NE 102, the UE 104, and so on.

At step 1, the AIOTF 530 may receive a service request from the AF 550. For example, the AF 550 (or an NEF) may transmit an AIoT service request message (e.g., a command request) for one or more AIoT devices, such as the AIoT device 510. The AIoT service request message may include identification information for one or more target AIoT devices (e.g., at least the AIOT device 510). The identification information may include, but is not limited to, filtering information, which applies to one or more components of AIoT device permanent identifiers and identifies a group of AIoT devices, and/or an AIoT device permanent identifier, which identifies a single AIoT device.

At step 2a, the AIOTF 530 may determine to request a T-ID. For example, in response to, or based at least in part on, the AIOTF 530 receiving the AIoT service request message, the AIOTF 530 may analyze (e.g., check) one or more parameters included in the AIoT service request message. In response to, or based at least in part on, an authorization (e.g., based at least on the one or more parameters) of the AIoT service request message, the AIOTF 530 may initiate an inventory procedure. In some cases, the AIOTF 530 may initiate the inventory procedure based at least in part on one or more rules, such as a rule associated with performing periodic inventory procedures.

In some cases, the AIOTF 530 may generate AIoT identification information, which the AIOTF 530 may transmit to the reader device 520. The AIOTF 530 may determine how to generate the AIoT identification information and whether to request a T-ID from the ADM 540. In some examples, when the AIoT identification information for one or more target AIoT devices (e.g., at least AIoT device 510) received at step 1 includes filtering information, the AIOTF 530 may determine to use the filtering information as AIoT device identification information (see step 3). As described herein, the filtering information may be transmitted within a paging ID in the paging message in clear text (e.g., without concealment), because the filtering information does not reveal device permanent identity information. In some other examples, when the AIoT identification information for one or more target AIoT devices (e.g., devices to be inventoried) includes one or more AIoT device permanent identifiers, the AIOTF 530 may check whether a setting (e.g., a local configuration at the AIOTF 530) that indicates the AIoT device identifier should be privacy protected, and may internally determine whether to apply, activate, and/or require privacy protection of the AIoT device identifier during the inventory procedure.

In some cases, when privacy protection during the inventory procedure is enabled (e.g., required), the AIOTF 530 may transmit a request to the ADM 540 for a T-ID. The AIOTF 530 may use the received T-ID within the AIoT identification information transmitted to the reader device 520 (see step 3). When privacy protection during the inventory procedure is not enabled (e.g., required), the AIOTF 530 may determine to use the AIoT device permanent identifier in the AIoT identification information transmitted to the reader device 520 (see step 3). In some cases, the AIOTF 530 may transmit an indication that indicates whether the T-ID is to be concealed and/or encrypted.

In some cases, the AIOTF 530 may retrieve a NONCE (e.g., a number used once, such as a random number or freshness parameter (e.g., RAND_{AIOT_n})), for use as a challenge to authenticate one or more target AIoT devices (e.g., at least AIoT device 510). The AIOTF 530 may select the reader device 520 and generate a correlation ID for the service request.

At step 2b, the AIOTF 530 may transmit a request to the ADM 540. For example, the AIOTF 530 may transmit a request message to retrieve information for the AIoT procedure (e.g., the inventory procedure), such as the type of AIoT device identifier and/or the security to use when encrypting/concealing the message. The request message may include AIoT device identification information (e.g., an AIoT device permanent ID or filtering information), an indication to request a nonce for the AIoT device 510 or a group of AIoT devices for the inventory procedure, an indication to request a T-ID, an indication as to whether the T-ID should be concealed/encrypted, and so on. The AIOTF 530 may determine whether to include a request indication to provide T-ID based on the operations described at step 2a.

In some cases, the AIOTF 530 may utilize a service procedure Nadm_Query request and include one or more the parameters. The one or more parameters may include: an AIoT device permanent ID (or filtering information), an indication to request a nonce for a group of AIoT devices (e.g., at least the AIoT device 510), an indication to request a T-ID, an indication as to whether the T-ID should be concealed/encrypted, and so on. In some cases, when the AIOTF 530 uses the filtering information as the AIoT device identification information, the AIOTF 530 may provide the ADM 540 with the filtering information and the request for the nonce (e.g., for the inventory procedure).

At step 2c, the ADM 540 may send a response to the AIOTF 530. For example, the ADM 540 may receive the request and may determine the information to be included in the response message (e.g., parameters, such as the AIoT device permanent ID or filtering information (as reference information to the request message), a nonce, a temporary ID, a temporary ID type, and so on).

The ADM 540 may determine the type of T-ID (e.g., Type B, C, or D) based on the following criteria: (1) the capabilities of the AIoT device (e.g., whether the AIoT device can perform a concealment operation) or whether the AIoT device can store a temporary ID, (2) a local configuration in the ADM 540 and/or an operator configuration (e.g., whether the T-ID should be pre-stored or not), (3) stored AIoT device subscription information (e.g., which may indicate the type of T-ID) for the particular AIoT device (e.g., the AIoT device subscription information may store an indication that T-ID of type C has to be used for the AIoT device), (4) information associated with a previous use or T-ID stored for the AIoT device (e.g., the ADM 540 may decide to use T-ID of type B as the stored T-ID), and so on.

At step 3, the AIOTF 530 may send an inventory request to the reader device 520. For example, the AIOTF 530 may transmit an inventory request message, such as an NGAP AIoT container message that includes an NGAP correlation ID, AIoT identification information, the type of identifier for the AIoT device, and so on. The format of the AIoT identification information may include independent or nested parameters, as depicted in FIGS. 3A-3B.

At step 4a, the reader device 520 may perform a paging procedure with the AIoT device 510. For example, the reader device 520 may create or generate an AIoT paging message to be transmitted (over the air) to the AIoT device 410. The AIoT paging message includes a paging ID, which contains the AIoT identification information (e.g., a value of the identifier for the AIoT device 510), and the AIoT identification info type (e.g., a type of the identifier).

At step 4b, the reader device 520 may transmit the paging message to the AIoT device 510.

At step 5a, the AIoT device 510 may perform a comparison of identifiers. For example, an access stratum (AS) layer of the AIoT device 510 may receive the paging message and may forward the paging ID to an NAS layer. As described herein, the paging ID may include the information about the AIoT identification info type and/or the AIoT device identification information. The NAS layer may determine the type of device identification information to use based on the paging ID. For example, the AIoT device 510 may create or use an internal identity, based on the received AIoT identification info type, and compare the internal identity with the received AIoT device identification information within the paging ID.

As a first example, when the received AIoT identification info type indicates filtering information (Type E), the AIoT device 510 may retrieve its AIoT device permanent identifier and perform the following operation. The AIOT device 510 determines whether the permanent identifier matches the filtering information by comparing the bitstring of every filtering element within the filtering information with an indicated component of the permanent identifier. When all of the compared bitstrings match the corresponding components of the permanent identifier, the AIoT Device 410 determines the permanent identifier matches the filtering information.

As a next example, when the received AIoT identification info type indicates a stored T-ID (Type B), the AIoT device 510 may retrieve an internally stored T-ID and compare the stored T-ID with the T-ID received in the paging ID;

As a next example, when the received AIoT identification info type indicates a concealed T-ID (Type C), the AIoT device 510 may de-conceal the T-ID received in the paging ID and compare the de-concealed T-ID with the internally stored T-ID;

As a next example, when the received AIoT identification info type indicates a concealed permanent identifier (Type D), the AIoT device 510 may de-conceal the T-ID received in the paging ID to generate a permanent identifier and compare the permanent identifier with an internally stored permanent identifier; and

As a final example, when the received AIoT identification info type indicates a permanent identifier (Type A), the AIoT device 510 may compares the device identification information from the paging ID with the permanent identifier; and so on.

In some cases, the AIoT device 510 may determine to prepare an inventory reply message when there is match between the compared identifiers.

Thus, in some examples, the AIoT device 510 may receive a paging request message from the reader device 520 that comprises a value of an identifier for the AIoT device 510 and an indication of a type of the identifier for the AIoT device 510, identify AIoT device identification information for the AIoT device 510 having the indicated type, and compare the value of the identifier for the AIoT device 510 with values of the identified AIoT device identification information.

At step 6, the AIoT device 510 may transmit a reply message to the reader device 520. For example, the AIoT device 510 may create a NAS inventory reply message and send the message within an AS D2R message to the reader device 520. The NAS inventory reply message may contain a NONCE (e.g., RAND_{AIOT_d}) created by the AIoT device 510 and may calculate a RES_{AIOT} using a K_{AIOT_root} and the NONCE received in the paging message (e.g., RAND_{AIOT_n}) to be used to authenticate the AIoT device 510.

At step 7, the reader device 520 may transmit an inventory response to the AIOTF 530. For example, the reader device 520 may transmit an inventory response message that includes an NGAP correlation ID and a NAS inventory reply message.

At step 8, the AIOTF 530 may transmit an authentication request to the ADM 540. For example, the AIOTF 530 may send the information received in the NAS inventory reply message to the ADM 540 in order to authenticate the AIoT device 510. The information may include various parameters, such as identification information (e.g., an AIoT device permanent identifier), the RES_{AIOT}, the RAND_{AIOT_n}, the RAND_{AIOT_d}, and so on. The ADM 540 may authenticate the information from the NAS inventory reply message and sends the result (e.g., a successful or failed authentication) to the AIOTF 530.

At step 9, the AIOTF 530 may send a service reply to the AF 550. For example, the AIOTF 530 may create and send a reply to the AF 550 that indicates a result for a successful reception and authentication of the inventory reply message.

Thus, in some examples, the AIoT device 510 is made aware about a type of identifier included in paging ID during an inventory procedure, or other AIoT operations. Using such knowledge, the AIoT device 510 may perform a comparison its identity with the identification information within the paging ID in a faster and more energy efficient manner, among other benefits.

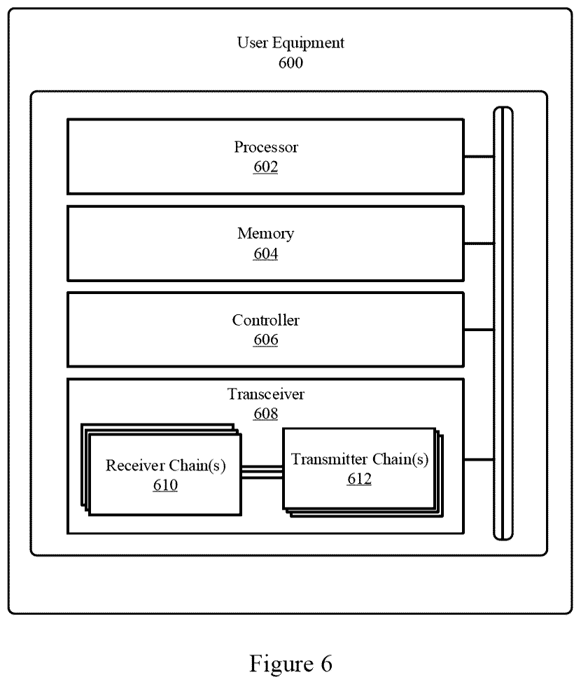

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 (e.g., as an AIoT device) may be configured to support a means for receiving a paging request message that comprises a value of an identifier for an AIoT device and an indication of a type of the identifier for the AIoT device, identifying AIoT device identification information for the UE having the indicated type, and comparing the value of the identifier for the AIoT device with values of the identified AIoT device identification information.

As another example, the UE 600 (e.g., as a reader device) may be configured to support a means for receiving a first message that comprises a value of an identifier for an AIoT device and a type of the identifier for the AIoT device and transmitting a second message to the AIoT device that includes the value of the identifier for the AIoT device and the type of the identifier for the AIoT device.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

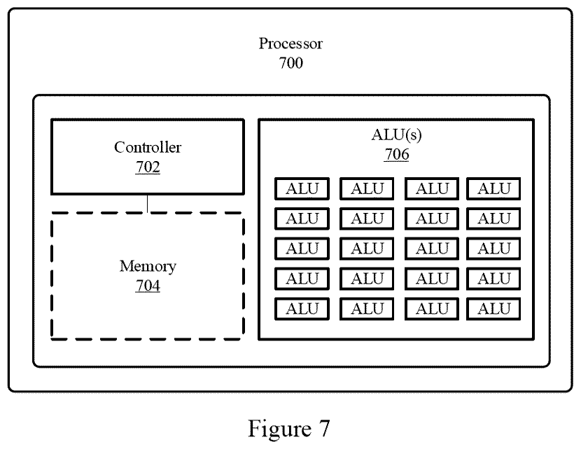

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving a paging request message that comprises a value of an identifier for an AIoT device and an indication of a type of the identifier for the AIoT device, identifying AIoT device identification information for the UE having the indicated type, and comparing the value of the identifier for the AIoT device with values of the identified AIoT device identification information.

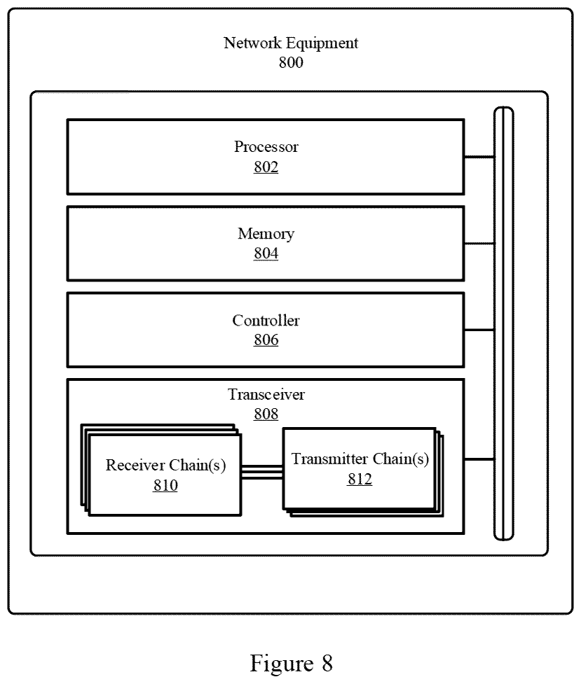

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 (e.g., as an AIOTF) may be configured to support a means for selecting a value of an identifier for an AIoT device and a type of the identifier for the AIoT device and transmitting, to an AIoT reader device, the selected value of the identifier for the AIoT device and the type of the identifier for the AIoT device.

As another example, the NE 800 (e.g., as a reader device) may be configured to support a means for receiving a first message that comprises a value of an identifier for an AIoT device and a type of the identifier for the AIoT device and transmitting a second message to the AIoT device that includes the value of the identifier for the AIoT device and the type of the identifier for the AIoT device.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

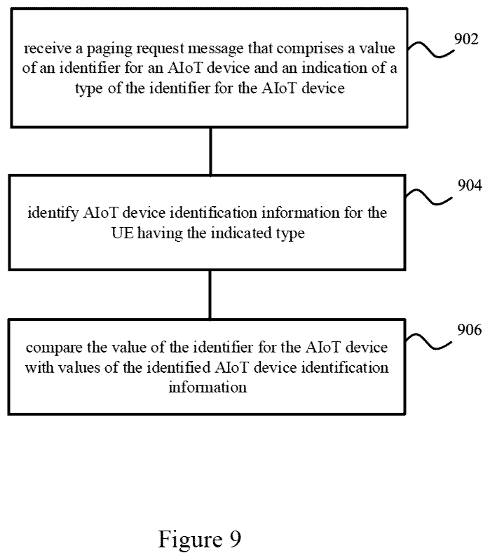

FIG. 9 illustrates a flowchart of a method in accordance with aspects of the present disclosure. The operations of the method may be implemented by a UE (e.g., an AIoT device) as described herein. In some implementations, the UE may execute a set of instructions to control the function elements of the UE to perform the described functions.

At 902, the method may include receiving a paging request message that comprises a value of an identifier for an AIoT device and an indication of a type of the identifier for the AIoT device. The operations of 902 may be performed in accordance with examples as described herein. In some implementations, aspects of the operations of 902 may be performed by a UE as described with reference to FIG. 6.

At 904, the method may include identifying AIoT device identification information for the UE having the indicated type. The operations of 904 may be performed in accordance with examples as described herein. In some implementations, aspects of the operations of 904 may be performed by a UE as described with reference to FIG. 6.

At 906, the method may include comparing the value of the identifier for the AIOT device with values of the identified AIoT device identification information. The operations of 906 may be performed in accordance with examples as described herein. In some implementations, aspects of the operations of 906 may be performed by a UE as described with reference to FIG. 6.

It should be noted that the method described herein describes a possible implementation, and that the operations and the steps may be rearranged or otherwise modified and that other implementations are possible.

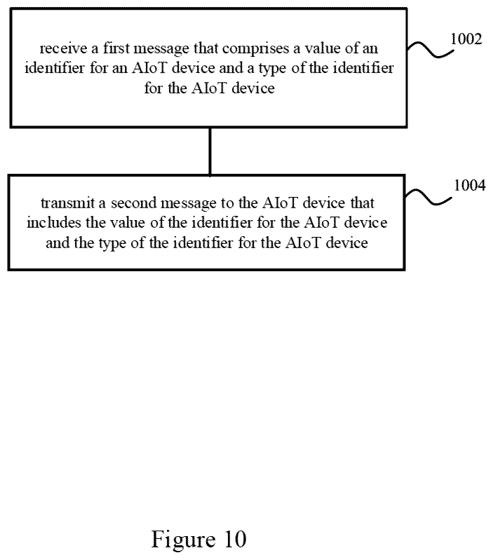

FIG. 10 illustrates a flowchart of a method in accordance with aspects of the present disclosure. The operations of the method may be implemented by a reader device (e.g., an NE or a UE) as described herein. In some implementations, the reader device may execute a set of instructions to control the function elements of the reader device to perform the described functions.

At 1002, the method may include receiving a first message that comprises a value of an identifier for an AIoT device and a type of the identifier for the AIOT device. The operations of 1002 may be performed in accordance with examples as described herein. In some implementations, aspects of the operations of 1002 may be performed by an NE as described with reference to FIG. 8.

At 1004, the method may include transmitting a second message to the AIoT device that includes the value of the identifier for the AIoT device and the type of the identifier for the AIoT device. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

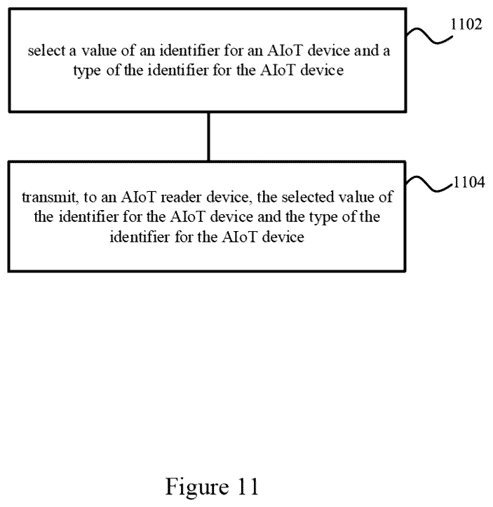

FIG. 11 illustrates a flowchart of a method in accordance with aspects of the present disclosure. The operations of the method may be implemented by an NE described herein. In some implementations, the NE may execute a set of instructions to control the function elements of the reader device to perform the described functions.

At 1102, the method may include selecting a value of an identifier for an AIoT device and a type of the identifier for the AIoT device. The operations of 1102 may be performed in accordance with examples as described herein. In some implementations, aspects of the operations of 1102 may be performed by an NE as described with reference to FIG. 8.

At 1104, the method may include transmitting, to an AIoT reader device, the selected value of the identifier for the AIoT device and the type of the identifier for the AIoT device. The operations of 1104 may be performed in accordance with examples as described herein. In some implementations, aspects of the operations of 1104 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network function for wireless communication, comprising:
one or more memories; and
one or more processors coupled with the one or more memories and individually or collectively configured to cause the network function to:
select a value of an identifier for an ambient Internet of Things (AIoT) device and a type of the identifier for the AIoT device; and
transmit, to an AIoT reader device, the selected value of the identifier for the AIoT device and the type of the identifier for the AIoT device.

2. The network function of claim 1, wherein the type of the identifier includes:
an AIoT device permanent identifier;
a temporary identifier (T-ID);
a concealed T-ID;
a T-ID generated based on a concealed AIoT device permanent identifier; or
filtering information.

3. The network function of claim 1, wherein the one or more processors are individually or collectively configured to cause the network function to:
determine whether privacy protection is enabled for AIoT;
transmit a request for a temporary identifier (T-ID) associated with the AIoT device based at least in part on privacy protection being enabled for AIoT, wherein the type of the identifier corresponds to the T-ID; and
receive the T-ID associated with the AIoT device.

4. The network function of claim 1, wherein, to transmit the selected value of the identifier for the AIoT device and the type of the identifier for the AIoT device, the one or more processors are individually or collectively configured to cause the network function to transmit an AIoT inventory request message comprising at least two parameters, including a parameter corresponding to the value of the identifier for the AIoT device and a parameter corresponding to the type of the identifier for the AIoT device.

5. The network function of claim 1, wherein, to transmit selected value of the identifier for the AIoT device and the type of the identifier for the AIoT device, the one or more processors are individually or collectively configured to cause the network function to transmit an AIoT inventory request message that includes the type of the identifier within device identification information for the AIoT device.

6. The network function of claim 1, wherein the one or more processors are individually or collectively configured to cause the network function to:
receive a request message for an AIoT inventory service or an AIoT command service,
wherein the value of the identifier for the AIoT device and the type of the identifier for the AIoT device is selected in response to, or based at least in part on, the received request message for the AIoT inventory service or the AIoT command service.

7. The network function of claim 1, wherein the network function is an AIoT function (AIOTF).

8. A reader device for wireless communication, comprising:
one or more memories; and
one or more processors coupled with the one or more memories and individually or collectively configured to cause the reader device to:
receive a first message that comprises a value of an identifier for an ambient Internet of Things (AIoT) device and a type of the identifier for the AIoT device; and
transmit a second message to the AIoT device that includes the value of the identifier for the AIoT device and the type of the identifier for the AIoT device.

9. The reader device of claim 8, wherein the second message is a paging message that includes the type of the identifier.

10. The reader device of claim 8, wherein the second message indicates the type of the identifier as a separate parameter.

11. The reader device of claim 8, wherein the second message indicates the type of identifier as part of a device identification information parameter.

12. The reader device of claim 8, wherein the reader device is a radio access network (RAN) node.

13. A user equipment (UE) for wireless communication, comprising:
one or more memories; and
one or more processors coupled with the one or more memories and individually or collectively configured to cause the UE to:
receive a paging request message that comprises a value of an identifier for an ambient Internet of Things (AIoT) device and an indication of a type of the identifier for the AIOT device;
identify AIoT device identification information for the UE having the indicated type; and
compare the value of the identifier for the AIoT device with values of the identified AIoT device identification information.

14. The UE of claim 13, wherein the type of the identifier for the AIOT device includes:
an AIoT device permanent identifier;
a temporary identifier (T-ID);
a concealed T-ID;
a T-ID generated based on a concealed AIoT device permanent identifier; or
filtering information.

15. The UE of claim 13, wherein the one or more processors are further individually or collectively configured to cause the UE to:
transmit a reply message when the value of the identifier for the AIoT device matches a value of the identified AIoT device identification information.

16. The UE of claim 13, wherein the type of the identifier is filtering information, and wherein, to compare the value of the identifier for the AIoT device with values of the identified AIoT device identification information, the one or more processors are further individually or collectively configured to cause the UE to:
compare each bitstring of each filtering element within the filtering information with a corresponding component of a permanent identifier of the UE; and
when each bitstring matches its corresponding component, determine that the permanent identifier matches the filtering information.

17. The UE of claim 13, wherein a non-access stratum (NAS) layer of the UE identifies the AIoT device identification information for the UE having the indicated type.

18. The UE of claim 13, wherein the UE is an AIOT device.

19. A method performed by a network function, the method comprising:
selecting a value of an identifier for an ambient Internet of Things (AIoT) device and a type of the identifier for the AIoT device; and
transmitting, to an AIoT reader device, the selected value of the identifier for the AIoT device and the type of the identifier for the AIOT device.

20. The method of claim 19, wherein the type of the identifier includes:
an AIoT device permanent identifier;
a temporary identifier (T-ID);
a concealed T-ID;
a T-ID generated based on a concealed AIoT device permanent identifier; or
filtering information.
